(19) United States
(12) Patent Application Publication
(10) Pub. No.: US 2014/0281226 A1
(43) Pub. Date: Sep. 18, 2014

(54) MEMORY CARD AND HOST DEVICE

(71) Applicant: KABUSHIKI KAISHA TOSHIBA, Minato-ku (JP)

(72) Inventors: Takeaki KATO, Yokohama-shi (JP); Hideo AIZAWA, Yokohama-shi (JP)

(73) Assignee: KABUSHIKI KAISHA TOSHIBA, Minato-ku (JP)

(21) Appl. No.: 14/018,816

(22) Filed: Sep. 5, 2013

Related U.S. Application Data
(60) Provisional application No. 61/792,621, filed on Mar. 15, 2013.

(51) Int. Cl. G06F 12/00

(52) U.S. Cl. CPC G06F 12/00
USPC 711/115

(57) ABSTRACT

According to one embodiment, a memory card includes a nonvolatile semiconductor memory which includes a first memory area that is not accessed by specifying an address thereof by a host device and a second memory area that is accessed by specifying an address thereof by the host device and stores read codes set to output preset data stored in the first memory area to the host device when the host device issues a plurality of commands to specified addresses in the second memory area in a specified order.

### CROSS-REFERENCE TO RELATED APPLICATIONS

This application claims the benefit of U.S. Provisional Application No. 61/792,621, filed Mar. 15, 2013, the entire contents of which are incorporated herein by reference.

### FIELD

Embodiments described herein relate generally to a high-quality memory card and a host device.

### BACKGROUND

Recently, an SD™ memory card is widely used as a storage device of data such as photographs. It is also desired to use an SD memory card for applications in which the maintenance of files once formed, for example, photographs used for formal materials is important.

### BRIEF DESCRIPTION OF THE DRAWINGS

FIG. 1 is a function block diagram schematically showing the main portions of a memory system and host device according to one embodiment.

FIG. 2 is a block diagram showing the register area of a memory according to one embodiment.

FIG. 3 is a diagram showing the configuration of the memory space of the memory.

FIG. 4 shows the state of the memory space formatted by a FAT file system.

FIG. 5 is a flowchart for illustrating the operation of outputting a register value to the host device by the memory card of the present embodiment.

FIG. 6A is a diagram showing addresses which the host device accesses and the order of reading in a concrete example 1.

FIG. 6B is a flowchart related to the concrete example 1.

FIG. 7A is a diagram showing addresses which the host device accesses and the order of reading in a concrete example 2.

FIG. 7B is a flowchart related to the concrete example 2.

FIG. 8A is a diagram showing addresses which the host device accesses and the order of reading in a concrete example 3.

FIG. 8B is a flowchart related to the concrete example 3.

### DETAILED DESCRIPTION

In general, according to one embodiment, a memory card includes a nonvolatile semiconductor memory which includes a first memory area that is not accessed by specifying an address thereof by a host device and a second memory area that is accessed by specifying an address thereof by the host device and stores read codes set to output preset data stored in the first memory area to the host device when the host device issues a plurality of commands to a specified addresses in the second memory area in a specified order, and

a controller which determines whether the host device issues the command to the specified address in the specified order and outputs preset data stored in the first memory area to the host device based on the read codes when determining that the host device issues the command to the specified address in the specified order.

Next, one embodiment is explained in detail with reference to the drawings. In the following explanation, the same symbols are attached to constituents having substantially the same functions and configurations and the repetitive explanation is made only when required. Further, the following embodiments are provided only as examples of devices and methods for embodying the technical idea of the embodiments and the technical idea of the embodiments does not specifically limit the materials, shapes, configurations, arrangements and the like of configuration parts to the items described below. The technical idea of the embodiments can be variously modified in the scope of the claims.

### Embodiment

<Configuration of Memory System>

FIG. 1 is a function block diagram schematically showing the main portions of a memory system and host device according to one embodiment. Each function block can be realized by use of one or both of hardware and computer software or a combination thereof. Therefore, the respective blocks are generally explained below from the viewpoint of their functions to make clear the configurations of the blocks. Whether the function is realized as hardware or software depends on the design restriction imposed on the concrete embodiment or the whole portion of the system. Those skilled in the art can realize the above functions by use of various methods for each concrete embodiment, but the technique of determining the realization is contained in the scope of this embodiment.

A memory system according to one embodiment is explained by taking an SD memory card (that is hereinafter simply referred to as a memory card) as an example.

<Configuration of Host Device>

In FIG. 1, a host device 1 includes hardware and software (system) to access a memory card 2. The host device 1 includes software such as applications, operating system and the like. The user gives an instruction to software 3 to perform the operation of writing data in the memory card 2 and reading data from the memory card 2. Then, the host device 1 makes a connection with the memory card 2 via an interface 5.

Driver software of a reader•writer 8 used for accessing an SD card (memory card) 2 connected to the exterior is stored in a storage (not shown) of the host device 1. When the host device 1 accesses the memory card 2, the software 3 of the host device 1 accesses the memory card 2 over the reader•writer 8 via a reader•writer in the host device 1. That is, a command system for communications is determined as a standard of an SD card and is issued from the reader•writer 8 to the memory card 2 according to the standard. Specifically, for example, a write instruction is issued from the host device 1 to the reader•writer 8 and a controller 8a of the reader•writer 8 recognizes the write instruction. Then, the controller 8a of the reader•writer 8 converts the write command to an SD card command and issues the same to the memory card 2. The memory card 2 receives the SD command from the reader•writer 8 to perform the write operation.

<Configuration of Reader•Writer>

The host device 1 and memory card 2 are connected to each other via the reader•writer 8.

The reader•writer 8 includes the reader•writer controller 8a, SD interface 9 and interface 10. The SD interface 9 is configured by hardware required for performing an interface process between the reader•writer 8 and the memory card 2 (controller 7). The SD interface 9 also has the configuration (the arrangement, the number of pins and the like) on hardware that can be connected to an SD interface 11 of the memory card 2. The interface 10 has the configuration that is to be connected to the interface 5 of the host device 1. Further, the controller 8a is configured by a RAM, ROM or the like and holds software (firmware) for controlling therein. The controller 8a receives an instruction from the host device 1 via driver software for the reader•writer 8. The controller 8a issues a command to the memory card 2 via the SD interface 11. As a result, the host device 1 is connected to the memory card 2 via the reader•writer 8.

Thus, since the host device 1 is connected to the memory card 2 via the reader•writer 8, it becomes difficult for the host device 1 to issue a command inherent to the SD memory card to the memory card 2.

<Configuration of Memory Card>

The memory card 2 receives power supply to perform an initialization operation when the card is connected to the host device 1 and when the host device 1 is turned on while the card is inserted in the host device 1 set in an off state and then performs a process corresponding to access from the host device 1. The memory card 2 has a memory controller 7 for controlling a memory (NAND flash memory) 6.

The memory 6 stores data in a nonvolatile fashion and writes and reads data in the unit called a page configured by a plurality of memory cells. A physical address inherent to each page is allocated to the page. Further, the memory 6 erases data in the unit called a physical block configured by a plurality of pages. A physical address may sometimes be allocated in the physical block.

The memory controller 7 manages the data storage state of the memory 6. The management of the storage state is to manage the relationship between a page (or physical block) of a physical address and data of a logical address (the logical address is allocated by the memory controller 7) held in the above page and what page (or physical block) of a physical address is set in the erase state (no data is written or invalid data is held therein).

The memory controller 7 includes the SD interface 11, MPU (microprocessing unit) 12, ROM (read only memory) 13, RAM (random access memory) 14 and NAND interface 15.

The SD interface 11 is configured by hardware and software required for performing an interface process between the reader•writer 8 and the memory controller 7. The memory card 2 (memory controller 7) makes communication with the host device 1 via the SD interface 11. Like the SD interface 9, the SD interface 11 also includes the configuration (the arrangement, the number of pins and the like) on hardware that makes it possible to perform the communication between them.

The MPU 12 controls the operation of the whole portion of the memory card 2. For example, the MPU 12 reads firmware (control program) stored in the ROM 13 onto the RAM 14 to perform a preset process when the memory card 2 receives power supply. The MPU 12 forms various tables (that are described later) on the RAM 14 according to the control program and receives a write command, read command and erase command from the host device 1 to perform a preset process for the memory 6.

The ROM 13 is a nonvolatile semiconductor memory device and stores a control program and the like controlled by the MPU 12. The RAM 14 is a volatile semiconductor memory device, is used as a working area of the MPU 12 and stores firmware (FW) and various tables stored in the memory 6. In the above tables, a conversion table (logical-physical table) that converts a logical address allocated to data by the memory controller 7 to a physical address of an actually stored page is contained. The NAND interface 15 performs an interface process between the memory controller 7 and the memory 6. Each time power is supplied to the memory card 2, FW or the like is supplied from the memory 6 to the RAM 14.

The storage area of the memory 6 is divided into a plurality of areas according to the types of data to be held. The plural areas include a system area 21, secure area 22, register area 23 and user area 24.

The system area 21 is an area provided in the memory 6 for the memory controller 7 to store data required for the operation thereof, stores management information mainly related to the memory card 2 and stores security information of the memory card 2 and card information such as media ID. The host device 1 cannot access the system area 21. Further, the memory controller 7 acquires part of the system area 21 to hold control data (logical-physical table, finally allocated logical block address to be described later or the like) required for the operation thereof.

The secure area 22 stores important data and secure data. The host device 1 can access the secure area 22, but this is limited to a case only after the validity of the host device 1 is verified based on mutual confirmation between the host device 1 and the memory card 2.

The register area 23 is a register specified according to the specification of the SD memory card. The register area 23 stores manufacture information of the memory card 2 and operation information for operating the memory card 2. The host device 1 cannot directly access the register area 23, but the host device 1 can read data of the register area 23 by use of a method described later.

The user area 24 can be freely accessed and used by the host device 1 and, for example, stores user data such as AV contents files and image data. In the following explanation, it is supposed that the memory 6 indicates the user area 24. The secure area 22 and user area 24 are logically formatted and file-managed as a different volume by the host device 1.

<Configuration of Register Area>

Next, the register area 23 of the memory 6 according to the present embodiment is explained with reference to FIG. 2.

As shown in FIG. 2, the register area 23 includes various registers such as a CID (card identification number), RCA (relative card address), DSR (driver stage register), CSD (card specific data), SCR (SD configuration data register), OCR (operation condition register), SSR (SD status register), CSR (card status register) and the like. In the CID, the card identification number or inherent number of the memory card 2 is stored. In the RCA, relative card addresses are stored. In the DSR, bus drive power of the memory card 2 or the like is stored. In the CSD, characteristic parameter values of the memory card 2 (information related to the card operation condition) are stored. The SCR is a register indicating the support function, configuration and the like of the SD card and, for example, holds information such as specification version corresponding to the SD card, a support status of a command provided as an option, a value (“0” or “F”) of the Erase state or the like. In the OCR, an operation voltage is stored when an operation voltage of the memory card 2 is limited. The SSR is a register indicating the characteristic of the card and, for example, holds information such as a speed class, access size (AU) for securing the speed class, size of data to be simultaneously erased and the like. In the CSR, information related to the card state is stored.

In this embodiment, data stored in the eight registers are referred to as register values or the like.

<Configuration of Memory>

Next, the configuration of the memory space of the memory 6 is explained with reference to FIG. 3. FIG. 3 is a diagram showing the configuration of the memory space of the memory 6.

As shown in FIG. 3, the memory 6 includes a normal memory area 31 and page buffer 32.

The memory area 31 includes a plurality of blocks BLK. Each physical block BLK is configured by a plurality of pages PG. Each page PG includes a plurality of memory cell transistors serially connected.

Each memory cell is configured by a MOSFET (metal oxide semiconductor field effect transistor) of a stacked gate structure. The MOS transistor with the stacked gate structure includes a tunnel insulating film, floating gate electrode, electrode-electrode insulating film, control gate electrode and source/drain diffusion layers. The threshold voltage of each memory cell transistor varies according to the number of electrons stored in the floating gate electrode and the memory cell transistor stores information corresponding to a difference in the threshold voltage. The memory cell transistor has the configuration that can take two or more states of different threshold voltages to store multi-valued data. A control circuit including a sense amplifier, potential generation circuit and the like of the memory 6 has the configuration that can write multi-bit data in the memory cell transistor and read multi-bit data therefrom.

The control gate electrodes of the memory cell transistors belonging to the same row are connected to the same word line. Selection gate transistors are provided on both ends of the memory cell transistors belonging to the same column and serially connected. One of the selection gate transistors is connected to a bit line. According to this rule, the memory cell transistors, selection gate transistors, word lines and bit lines are provided. The data writing and data reading operations are performed for each set of plural memory cell transistors and a memory area configured by the set of memory cell transistors corresponds to one page.

In the case of the example shown in FIG. 3, each page PG has 2112 bytes (data storage of 512 bytes×4+redundancy unit of 10 bytes×4+management data storage of 24 bytes) and each block BLK is formed of 128 pages, for example.

The page buffer 32 inputs and outputs data with respect to the memory 6 and temporarily stores data. The size of data that the page buffer 32 can hold is the same as that of the size of page PG and is set to 2112 bytes (2048 bytes+64 bytes), for example. At the data write time, for example, the page buffer 32 performs a data input/output process with respect to the memory 6 in the unit of one page corresponding to its own memory capacity. The data erase process is performed in the unit of physical block BLK.

Further, the memory 6 has a mode in which one-bit data can be written in one memory cell transistor and a mode in which multi-bit data, that is, data of 2n (n is a natural number) values can be written in one memory cell transistor. The mode of the memory 6 in which one-bit data is written in one memory cell transistor is called a binary mode and the mode in which multi-bit data is written is called a multi-value mode.

<Format of Memory>

Next, the format of the memory card 2 is explained. The memory 6 is formatted in the following form.

Generally, the memory card 2 is shipped in the FAT formatted state. In this case, the user can format the memory card 2 by executing a formatting application on the host device 1.

<FAT File System>

Before explaining the formatting of the memory 6 by use of a file system according to one embodiment of this embodiment, the outline of a FAT file system on which the file system is based is explained with reference to FIG. 4. FIG. 4 shows the state of a memory space formatted by a FAT file system. Some of management data described below are written therein. The memory space described here is a memory area which the FAT file system can freely access and corresponds to the user area 24 in the memory 6 of FIG. 1.

As shown in FIG. 4, the FAT file system manages clusters with preset size (for example, 16 kbytes) obtained by dividing the memory space of a to-be-managed memory.

The memory space of the memory 6 is divided into an area 41 allocated to a master boot record (MBR) and partition table, an area 42 allocated to a partition boot sector, an area 43 allocated to FAT and an area 44 allocated to user data.

In the area 41, an area 41a allocated to a master boot record (MBR) and partition table and reserved area 41b are provided.

The master boot record is one type of a boot sector and indicates a boot sector that is a head sector (outside the partition) on the disk having a plurality of divided partitions. In the master boot record, a partition table is contained and the partition table stores information including a file system type of each partition, the head sector thereof and the like.

The area 42 includes areas 42a, 42e allocated to a partition boot sector, areas 42b, 42f allocated to an FS information sector, reserved areas 42c, 42g for the boot sector and reserved areas 42d, 42h. The areas 42e, 42f and 42g are backup areas of the areas 41a, 42b and 42c.

The boot sector is located in the head sector indicated by the partition table and includes BPB (BIOS parameter block). BPB indicates various parameters of the memory 6 used by the file system. The FAT file system writes the parameters when the memory is formatted. The FAT file system reads BPB at the start time to recognize the parameters of the file format.

FAT1 and FAT2 are allocated to the area 43 and FAT1 indicates the type of a cluster in which part of file data (that is hereinafter simply referred to as file data) written in the memory and divided into cluster size is stored and a connection of clusters for restoration of file data. FAT2 is a backup of FAT1 and stores the same contents as those of FAT1.

Since file data configuring one file are not necessarily allocated to successive clusters, the FAT file system allocates available clusters to file data without paying any attention to the order of cluster numbers (randomly). FAT1, FAT2 store the connection relationship of the clusters that store the file data. The original file is restored by tracing information stored in FAT1, FAT2 (that are hereinafter simply referred to as FAT).

In the area 44, actual file data and directory entry are held as user data.

<Register Value Read Code>

Next, the register value read code used by the MPU 12 when the host device 1 reads data of the register area 23 is explained.

The register value read code is a code that outputs preset data of the register area 23 to the host device 1 by the MPU 12 when a plurality of specified steps are performed on specified order (that is also referred to as an access sequence, command sequence or the like) by the host device 1.

The specified step defined by the register value read code indicates an operation of the host device 1 that issues a read command to a specified address or issues a write command to a specified address. As the specified address, for example, the address of the reserved area 41b, 42d or 42h explained with reference to FIG. 4 is used.

The register value read code is previously incorporated in the firmware (FW) of the memory card 2 and is stored in a preset area of the memory 6. When the memory card 2 is started, FW stored in the memory 6 is read to the RAM 14 and, as a result, the MPU 12 can determine whether the register value is output or not by use of the register value read code in the RAM 14. If the host device 1 performs all of the steps set in the register value read code in the specified order, FW is set to output a preset register value to the host device 1 as the output result of the final step set in the register value read code.

The host device 1 can read a preset register value by performing operations in an access sequence set in a preset register value read code defined to read the preset register value with respect to the memory card 2.

The register value read code is prepared for each register value, for example. In the case of this embodiment, for example, since eight types of register values are prepared in the register area 23, eight types of register value read codes used for reading the respective register values are prepared.

In this embodiment, at least one of the type and the number of specified steps defined by the eight types of register value read codes and the operation order of the specified steps is different.

<Register Value Outputting Method>

Next, the operation of outputting the register value of the register area 23 to the host device 1 by the memory card 2 according to this embodiment is explained with reference to FIG. 5.

When receiving a command and address from the host device 1, the MPU 12 determines whether or not the received command and address are a command and address related to the first step of one of a plurality of register value read codes set in FW.

If it is determined in step S1001 that the received command and address are the command and address related to the first step of one of the plural register value read codes set in FW, the MPU 12 starts the operation of determination of the register value read code in which the received command and address are defined as the first step. In this case, the register value read code is simply called a first code.

As explained above, the first code is set to cause the memory card 2 to output a preset register value to the host device 1 by causing the host device 1 to issue read commands or write command to a plurality of specified addresses in a specified order. As a result, the MPU 12 determines whether or not the host device 1 performs the specified steps set in the first code in the specified order.

For example, when the host device 1 makes accesses to the addresses related to the steps set in the first code in an order that is not set in the first code while the MPU 12 is performing the above determination operation, the MPU determines that the host device 1 does not perform the specified steps set in the first code in the specified order. As a result, the MPU 12 determines that the register value read operation ends in failure and terminates (resets) the register value read operation.

When the power supply of the memory card 2 is interrupted or the memory card 2 is initialized while the MPU 12 is performing the above determination operation, the MPU 12 terminates (resets) the code determination operation.

If the MPU 12 terminates (resets) the code determination operation, the MPU 12 returns the process to step S1001.

Further, the host device 1 may perform a preset step with respect to an address that is not related to the step set in the first code while the MPU 12 is performing the above determination operation. That is, in this embodiment, the MPU 12 permits access to an address that is not related to the register value read code.

When the MPU 12 determines that the host device 1 performs all of the steps set in the first code in the specified order, the MPU 12 outputs a preset register value related to the first code to the host device 1 as the output result of the final step set in the first code.

After the MPU 12 outputs the preset register value, the MPU 12 terminates (resets) the code determination operation.

<Operation and Effect of Present Embodiment>

According to the above embodiment, a code used for reading a preset register value is set in FW of the memory card 2. The host device 1 can read a preset register value set in the memory area that cannot be directly accessed by the host device 1 from the memory card 2 by performing the step set as the code in a correct order.

Normally, when the memory card 2 outputs the register value to the host device 1, the host device 1 is required to include a special application programming interface (API) used for reading the register value. However, the host device 1 can easily acquire various register values of an SD memory card without installing the API by using the memory card 2 according to this embodiment.

As described above, a desired register value can be acquired by use of an application operated on a desired host device 1 by performing a series of steps (access sequence) related to the code explained in the present embodiment by utilizing an interface used in a general memory system. As a result, for example, the memory card can be used for various services in which a host application identifies a specified SD memory card or a specified unique ID of the SD memory card is used as an authentication key.

When the host device 1 erroneously performs the procedure of the code or unwanted interruption of the power supply of the memory card 2 or initialization thereof occurs, the MPU 12 terminates (resets) the code determination operation. As a result, the operation of outputting data of an unexpected register value can be prevented.

When the host device 1 correctly performs the procedure related to the code and, as a result, the memory card 2 outputs a desired register value, the MPU 12 terminates (resets) the code determination operation at this time. As a result, like the case of erroneously performing the procedure, the operation of outputting data of an unexpected register value can be prevented.

Further, access that is not related to the code may occur while the host device 1 is correctly performing the procedure related to the code. In this case, the MPU 12 can make the access without interfering the register value outputting procedure even when a plurality of processes of a multitask occur in the memory card 2 by not including the access in the code determination operation.

Next, a concrete example of the register value read operation is explained to make it easier to understand the operation of this embodiment.

In the following concrete example, a “CID read code” used for outputting a preset register value, for example, a CID value is set in FW of the memory card 2. In the “CID read code”, it is defined that the memory card 2 outputs the CID value to the host device 1 by causing the host device 1 to sequentially perform the following five steps.

The five steps are as follows:
First step S1ex: issue read command to address A
Second step S2ex: issue read command to address B
Third step S3ex: issue read command to address C
Fourth step S4ex: issue read command to address D

Fifth step S5ex: issue read command to address E

For example, addresses A, B, C, D and E are addresses of the reserved areas 41b, 42d, 42h explained in FIG. 4.

### Concrete Example 1

The operation related to a concrete example 1 is explained with reference to FIGS. 6A, 6B. FIG. 6A is a diagram showing addresses which the host device 1 accesses and the order of reading in the concrete example 1 and FIG. 6B is a flowchart related to the concrete example 1.

The host device 1 issues a read command to address A. When receiving a read command for address A from the host device 1, the MPU 12 starts a determination process to determine whether or not a “read command for address A” is a CID read code incorporated as first step S1ex. The memory card 2 outputs data of address A to the host device 1. The host device 1 may discard data of address A when issuing a read command to address A for the purpose of CID reading. Likewise, in the following steps, the host device 1 may discard data other than the target data.

Next, the host device 1 issues a read command to address B. The MPU 12 recognizes that the host device 1 has performed second step S2ex after first step S1ex of the CID read code. The memory card 2 outputs data of address B to the host device 1.

Then, the host device 1 issues a read command to address C. The MPU 12 recognizes that the host device 1 has performed third step S3ex after second step S2ex of the CID read code. The memory card 2 outputs data of address C to the host device 1.

Subsequently, the host device 1 issues a read command to address D. The MPU 12 recognizes that the host device 1 has performed fourth step S4ex after third step S3ex of the CID read code. The memory card 2 outputs data of address D to the host device 1.

After this, the host device 1 issues a read command to address E. The MPU 12 recognizes that the host device 1 has performed fifth step S5ex after fourth step S4ex of the CID read code.

The memory card 2 recognizes that the host device 1 sequentially performs steps S1ex to S5ex set in the CID read code. As a result, the MPU 12 determines that the CID read code is executed and the memory card 2 outputs not data of address E but a CID value to the host device 1 as the output result of address E. At this time, the determination operation of the CID read code is terminated. Even when the host device 1 performs only final step 5ex after a desired register value is output, the memory card 2 does not output a desired register value. That is, even when the host device 1 reads a preset register value again, it becomes necessary to perform the preset steps in a correct order from the beginning.

As described above, the host device 1 can read a preset register value that cannot be read by use of a normal read command from the memory card 2 by performing the steps corresponding to the code previously set in FW of the memory card 2 in a correct order.

### Concrete Example 2

The operation related to a concrete example 2 is explained with reference to FIGS. 7A, 7B. FIG. 7A is a diagram showing addresses which the host device 1 accesses and the order of reading in the concrete example 2 and FIG. 7B is a flowchart related to the concrete example 2.

The host device 1 issues a read command to address A. When receiving a read command for address A from the host device 1, the MPU 12 starts a determination process to determine whether or not a “read command for address A” is a CID read code incorporated as first step S1ex. The memory card 2 outputs data of address A to the host device 1. The host device 1 may discard data of address A when issuing a read command to address A for the purpose of CID reading. Likewise, in the following steps, the host device 1 may discard data other than the target data.

Next, the host device 1 issues a read command to address B. The MPU 12 recognizes that the host device 1 has performed second step S2ex after first step S1ex of the CID read code. The memory card 2 outputs data of address B to the host device 1.

Then, the host device 1 issues a read command to address C. The MPU 12 recognizes that the host device 1 has performed third step S3ex after second step S2ex of the CID read code. The memory card 2 outputs data of address C to the host device 1.

Subsequently, the host device 1 issues a read command to address D. The MPU 12 recognizes that the host device 1 has performed fourth step S4ex after third step S3ex of the CID read code. The memory card 2 outputs data of address D to the host device 1.

After this, the host device 1 issues a read command to address D. The MPU 12 recognizes that the host device 1 has performed fourth step S4ex after fourth step S4ex of the CID read code. The MPU 12 determines that the command is not a CID read code since the host device 1 makes an error in setting the order of the step corresponding to the CID read code. However, the memory card 2 outputs data of address D to the host device 1 according to the read command.

At this time, if the CID read code determination process is terminated and the host device 1 reads CID from the memory card 2, it is necessary to sequentially perform the steps related to the CID read code from the beginning.

Next, the host device 1 issues a read command to address E. CID is not output to the host device 1 even if fifth step S5ex of the CID read code is performed since the MPU 12 determines at the time of step S3005 that the command is not a CID read code. However, the memory card 2 outputs data of address E to the host device 1 according to the read command.

As described above, if the host device 1 makes an error in setting the order of steps related to the steps corresponding to the code previously set in FW of the memory card 2, the memory card 2 determines that the command is not the target code. As a result, the memory card 2 can more precisely determine reading of the register value.

### Concrete Example 3

The operation related to a concrete example 3 is explained with reference to FIGS. 8A, 8B. FIG. 8A is a diagram showing addresses which the host device 1 accesses and the order of reading in the concrete example 3 and FIG. 8B is a flowchart related to the concrete example 3.

The host device 1 issues a read command to address A. When receiving a read command for address A from the host device 1, the MPU 12 starts a determination process to determine whether or not a “read command for address A” is a CID read code incorporated as first step S1ex. The memory card 2 outputs data of address A to the host device 1. The host device 1 may discard data of address A when issuing a read command to address A for the purpose of CID reading. Likewise, in the following steps, the host device 1 may discard data other than the target data.

Next, the host device 1 issues a read command to address B. The MPU 12 recognizes that the host device 1 has performed second step S2ex after first step S1ex of the CID read code. The memory card 2 outputs data of address B to the host device 1.

Then, the host device 1 issues a read command to address C. The MPU 12 recognizes that the host device 1 has performed third step S3ex after second step S2ex of the CID read code. The memory card 2 outputs data of address C to the host device 1.

Subsequently, the host device 1 issues a read command to address D. The MPU 12 recognizes that the host device 1 has performed fourth step S4ex after third step S3ex of the CID read code. The memory card 2 outputs data of address D to the host device 1.

After this, the host device 1 issues a read command to address F. The MPU 12 recognizes that the host device 1 has performed the step that is not related to the CID read code. The MPU 12 maintains the process of determining whether or not the command is a CID read command in the state of step S4004. The memory card 2 outputs data of address F to the host device 1.

Next, the host device 1 issues a read command to address E. The MPU 12 recognizes that the host device 1 has performed fifth step S5ex after fourth step S4ex of the CID read code although it has performed a step that is not related to the CID read code.

The memory card 2 recognizes that the host device 1 performs steps S1ex to S5ex set in the CID read code in a correct order. As a result, the memory card 2 outputs not data of address E but a CID value to the host device 1 as the output result of address E.

As described above, even if the step that is not related to the CID read code is performed while the host device 1 is performing the steps corresponding to the code previously set in FW of the memory card 2 in a correct order, the MPU 12 does not take into consideration the step that is not related to the CID read code in the determination operation for determining whether the command is a CID read code or not. Therefore, the host device 1 can read other data in the course of the operation of reading a preset register value and suppress a lowering in the system performance caused by a preset register value read operation.

<Modification and Others>

In each of the concrete examples 1 to 3, the host device 1 reads a preset register value by issuing read commands in a preset order with respect to the preset addresses of the memory card 2.

However, the embodiment is not limited to the above case and a code used for reading a preset register value by causing the host device 1 to issue write commands in a preset order to preset addresses of the memory card 2 may be set in FW.

Further, a code used for reading a preset register value by causing the host device 1 to issue write commands and read commands in a preset order to preset addresses of the memory card 2 may be set in FW.

In the concrete examples 1 to 3, five procedures are set in the code and the memory card 2 outputs a preset register value to the host device 1 by performing the five procedures by the host device 1. However, the embodiment is not limited to this case and it is sufficient if two or more procedures are set in the code.

Further, in the above embodiment, the memory card 2 outputs one register value to the host device 1 by performing the procedures corresponding to the preset code by the host device 1, but the embodiment is not limited to this case. For example, the memory card 2 may output all register values or a plurality of register values to the host device 1 by performing the procedures corresponding to a preset code by the host device 1.

In the above embodiment, since eight types of register values are prepared in the register area 23, eight types of register value read codes used for reading the respective register values are prepared. However, the embodiment is not necessarily limited to the above case and a register in which no register value read code is set may be provided.

Further, in the above embodiment, a plurality of register value read codes are prepared in FW of the memory card 2, but the embodiment is not necessarily limited to this case and only one register value read code may be prepared.

In the above embodiment, an address of the reserved area of the user area 24 is used as an address used in the code for reading a register value, but the embodiment is not limited to this case. Specifically, an address of an area other than the user area 24 may be used if the area can be accessed by the host device 1. Further, if an address that is not normally accessed by the host device 1 is used as an address used in the code for reading a register value, the operation of reading an unexpected register value (erroneous operation) can be prevented.

In the above embodiment, the host device 1 and memory card 2 are connected via the reader•writer 8 that includes the SD interface, but the embodiment is not limited to this case. For example, the host device 1 itself may include an SD interface.

In the above embodiment, eight types of register values are set in the register area 23, but the embodiment is not necessarily limited to this case.

Further, in the above embodiment, a register value read code is set and prepared to read a register value, but the embodiment is not necessarily limited to this case. A code used for reading the memory area of the memory 6 that cannot be directly accessed by the host device 1 can be applied in the above embodiment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A memory card comprising:
a nonvolatile semiconductor memory which includes a first memory area that is not accessed by specifying an address thereof by a host device and a second memory area that is accessed by specifying an address thereof by the host device and stores read codes set to output preset data stored in the first memory area to the host device when the host device issues a plurality commands to specified addresses in the second memory area in a specified order, and
a controller which determines whether the host device issues the commands to the specified addresses in the specified order and outputs preset data stored in the first memory area to the host device based on the read codes when determining that the host device issues the commands to the specified addresses in the specified order.

2. The memory card of claim 1, wherein the controller does not use a first command for the determination when the first command is issued to an address that is not set in the read codes from the host device.

3. The memory card of claim 1, wherein the controller terminates the determination when one of a command that is provided for an address set in the read codes but is not set in the read codes and commands to the specified addresses in an order different from the specified order is issued.

4. The memory card of claim 1, wherein the controller terminates the determination when one of a case in which power supply to the memory card is interrupted and a case in which the memory card is initialized occurs.

5. The memory card of claim 1, wherein the first memory area stores plural types of register data.

6. The memory card of claim 5, wherein the nonvolatile semiconductor memory stores the read codes that are different for the respective register data.

7. The memory card of claim 5, wherein the controller outputs the plural register data by performing an operation corresponding to one of the read codes.

8. The memory card of claim 1, wherein the commands are a write command and read command.

9. The memory card of claim 1, wherein data stored in the first memory area is information inherent to the memory card and operation information for operating the memory card.

10. A host device which is connected to a memory card that includes a nonvolatile semiconductor memory which includes a first memory area that is not accessed by specifying an address and a second memory area that is accessed by specifying an address and stores a read codes set to output preset data stored in the first memory area when commands to specified addresses in the second memory area is issued in a specified order, and
a controller which determines whether the commands are issued to the specified addresses in the specified order and outputs a preset value stored in the first memory area based on the read codes when determining that the commands are issued to the specified addresses in the specified order,
wherein commands are issued to a specified addresses in the second memory area in a specified order based on the read codes when data in the first memory area is read.

11. The host device of claim 10, wherein the first memory area stores plural types of register data, the nonvolatile semiconductor memory stores the read codes that are set different for the respective register data and commands to a specified addresses in the second memory area is issued in a specified order based on the read codes set to output preset register data to the memory card to acquire the preset register data.

12. The host device of claim 10, wherein the commands are a write command and read command.
